(19) United States
(12) Patent Application Publication
(10) Pub. No.: US 2025/0050472 A1
(43) Pub. Date: Feb. 13, 2025

(54) MULTI-MODEL PIPE JOINT CONNECTION DEVICE

(71) Applicant: Guofen Luo, Dongguan City (CN)

(72) Inventor: Guofen Luo, Dongguan City (CN)

(21) Appl. No.: 18/366,584

(22) Filed: Aug. 7, 2023

(51) Int. Cl. B25B 5/14; B25B 5/10

(52) U.S. Cl. CPC B25B 5/147; B25B 5/10

(57) ABSTRACT

A multi-model pipe joint connection device, which includes a main body, a pipe body clamping mechanism located on one side of the main body for clamping the pipe body, a supporting part with an internal space, a joint positioning fixture that can be detachably assembled in the internal space and used for clamping the joint, and a power part located on the other side of the main body. The power part is capable of driving the supporting part towards the pipe body clamping mechanism, enabling the joint clamped within the joint positioning fixture to connect to the end of the pipe body held by the pipe body clamping mechanism. The invention employs the pipe body clamping mechanism and joint positioning fixture to achieve quick positioning of the pipe body and joint, respectively, and uses the power part to enable the positioned joint to enter the positioned pipe body.

### TECHNICAL FIELD

The present invention relates to the field of connecting device technology used to connect pipe bodies with joints, particularly to a multi-model pipe joint connection device.

### BACKGROUND ART

A pipe body, such as a hose, generally refers to a transport device used to convey fluids like gas or liquid to mechanical equipment. Usually, to facilitate quick connection of the hose with other pipe fittings or equipment, a joint is typically assembled at the connecting end of the hose. The specifications of pipe openings vary widely in international standards, and the corresponding specifications of the joints that need to be assembled are also diverse. In traditional assembly processes, the joints are usually manually assembled to the pipe's connecting end, an operation that is difficult, with low production efficiency, and not conducive to mass production. Therefore, it is necessary to make improvements.

### SUMMARY OF THE INVENTION

In view of the deficiencies in existing technology, the object of the present invention is to provide a multi-model pipe joint connection device.

To achieve the above object, the technical solution adopted by the present invention is:

A multi-model pipe joint connection device, comprising a main body, a pipe holding mechanism located on one side of the main body for clamping a pipe body, a carrier with an internal space, a joint locating fixture that is detachably assembled in the internal space for holding a joint, and a power component located on the other side of the main body; wherein the power component can drive the carrier to approach the pipe holding mechanism, enabling the joint held in the joint locating fixture to connect to one end of the pipe body held by the pipe holding mechanism.

More preferably, wherein the pipe holding mechanism includes a fixed seat fixedly disposed on the main body, two positioning seats slidingly disposed on the fixed seat, and a transmission component; the two positioning seats are arranged symmetrically on the left and right, and the transmission component is transmissionally connected to the two positioning seats respectively, and the transmission component can drive the two positioning seats to approach each other to clamp the pipe body.

More preferably, wherein each of the positioning seats includes a slider, a pipe clamp, and a locking component; the slider is slidably mounted on the fixed seat; the pipe clamp is fixedly connected to the slider through the locking component, and the pipe clamp has a pipe clamping groove.

More preferably, wherein the pipe clamping groove of the pipe clamp is shaped with corrugated teeth corresponding to the corrugated structure of the pipe body.

More preferably, wherein the transmission component includes a bidirectional screw rotationally mounted on the fixed seat and a rotating handle mounted on one end of the bidirectional screw; the bidirectional screw has a forward thread portion and a reverse thread portion.

More preferably, wherein the carrier includes a main shell, a split shell hinged to the main shell, and a locking part mounted on the main shell; the main shell has a first split groove; the split shell has a second split groove; the first split groove and the second split groove are combined to form the internal space of the carrier; and the locking part is used to open or lock the split shell relative to the main shell for the joint locating fixture to be put in or taken out.

More preferably, wherein the locking part includes a reset elastic component and a locking plug; the main shell has a first column hole, a locking slot communicating with the first column hole, and a second column hole communicating with the locking slot; the split shell has a buckle foot that can extend into the locking slot; one end of the locking plug is equipped with a stop part for keeping the buckle foot inside the locking slot; the reset elastic component is located in the second column hole; the end of the locking plug with the stop part passes through the first column hole, the locking slot, and extends into the second column hole, pushing against the reset elastic component; the other end of the locking plug is exposed at the first column hole.

More preferably, wherein the joint locating fixture includes two positioning blocks that are set in halves and are relatively independent; each positioning block has a positioning groove; the two positioning blocks are assembled in a matching manner and used in conjunction, and after the positioning groove of the two positioning blocks are aligned, a positioning space for clamping the joint is formed.

More preferably, wherein each of the positioning blocks has an internal thread part formed at one end away from the positioning groove, for guiding the end of the pipe body to extend into the positioning space.

More preferably, wherein the power member includes a base, a rotary screw, and a power handle; the base has a second threaded hole; the rotary screw is rotatably assembled in the second threaded hole of the base; one end of the rotary screw is fixedly connected with the carrier, and the other end of the rotary screw is fixedly connected with the power handle; the power handle can drive the carrier towards the pipe holding mechanism through the rotary screw, so that the joint is screwed into the end of the pipe body.

By adopting the above structure, the advantages of the present invention compared to the existing technology are:

The invention realizes the rapid positioning of the pipe body and joint through the pipe body clamping mechanism and joint positioning fixture, respectively. The positioned joint can be inserted into the positioned pipe body through the power component, and the joint positioning fixture is designed to be detachable, enabling the quick replacement of corresponding specifications of joints. This facilitates the rapid assembly of various models of pipe bodies and joints, making user operation very convenient and offering strong versatility.

### BRIEF DESCRIPTION OF THE DRAWINGS

Further illustration of the present invention is provided below, in conjunction with the accompanying drawings and examples.

FIG. 1 is a schematic diagram of the structure of the present invention;

FIG. 2 is a schematic diagram of the structure of the present invention from another perspective;

FIG. 3 is a partial schematic diagram of the present invention, with the pipe body placed inside the pipe body clamping mechanism and the joint placed inside the joint positioning fixture;

FIG. 4 is a schematic diagram of the structural decomposition of the pipe body clamping mechanism of the present invention;

FIG. 5 is a schematic diagram of the structure of the supporting part and joint positioning fixture of the present invention;

FIG. 6 is a schematic diagram of the structural decomposition of the supporting part, joint positioning fixture, and locking part of the present invention.

FIG. 7 is a schematic diagram of the structural decomposition of the supporting part, joint positioning fixture, and locking part of the present invention.

### DETAILED DESCRIPTION OF THE EMBODIMENTS

The following are only preferred embodiments of the present invention, and should not limit the scope of the invention.

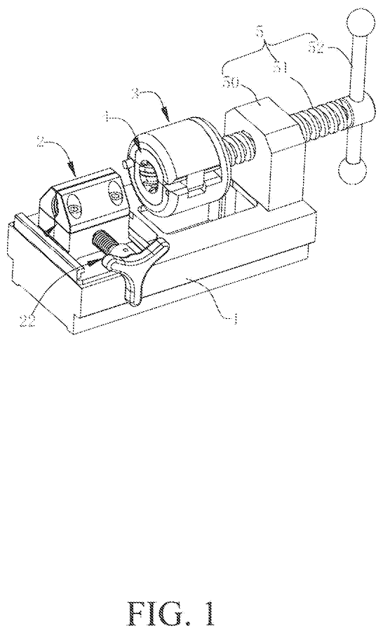

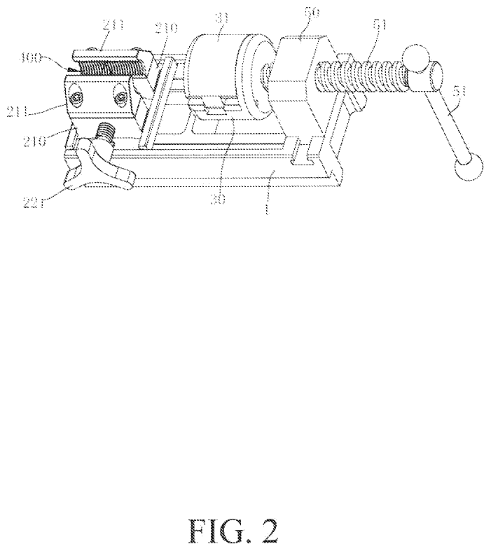

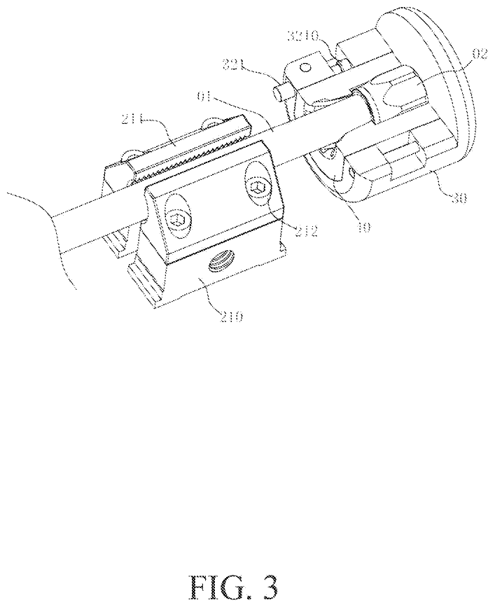

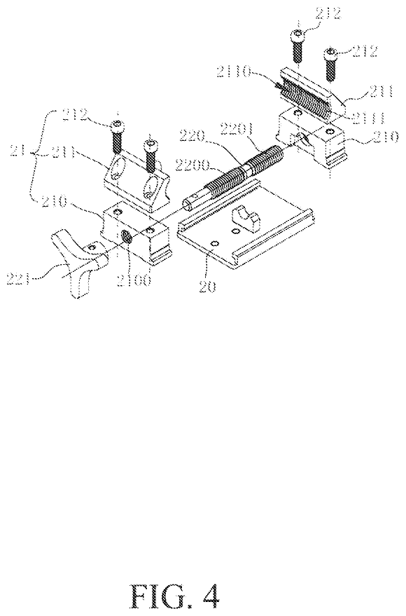

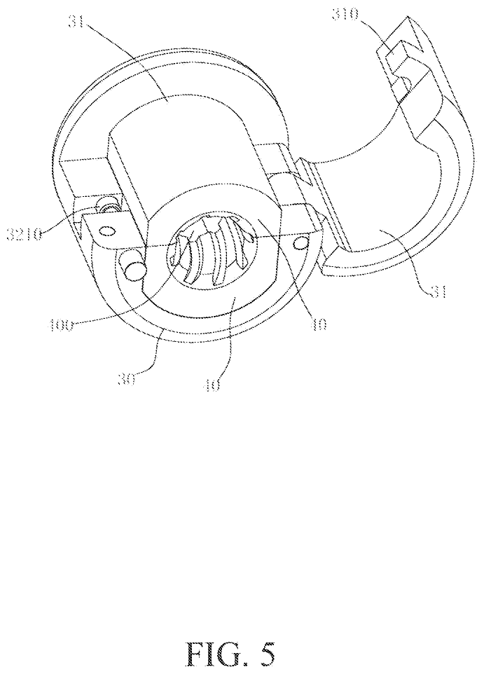

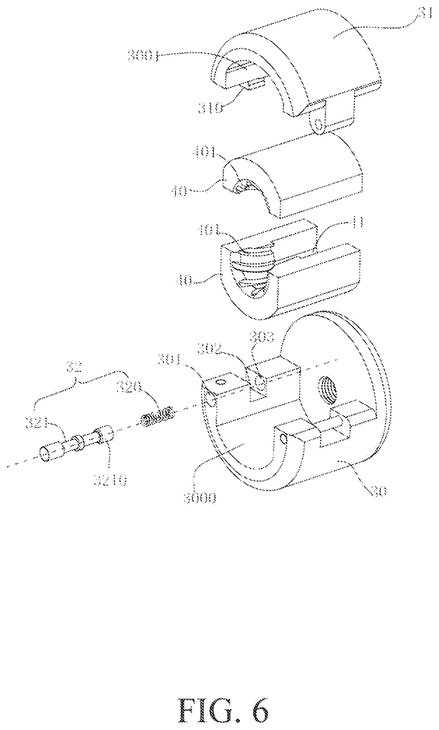

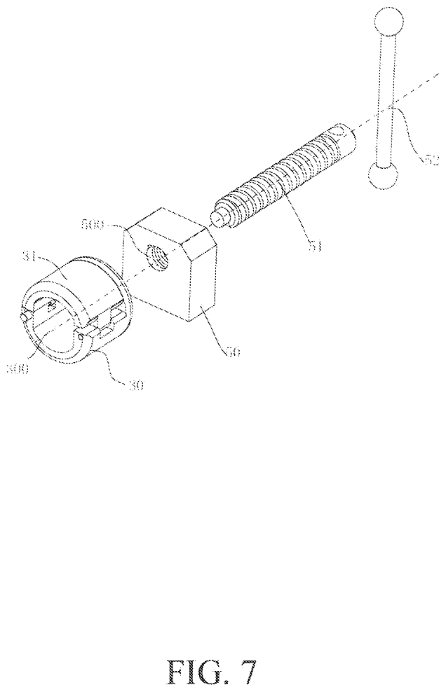

As shown in FIGS. 1 to 7, the present invention provides a multi-model pipe joint connection device, which comprises a main body 1, a pipe holding mechanism 2 located on one side of the main body 1 for clamping the pipe body 01, a carrier 3 with an internal space 300, a joint locating fixture 4 that is detachably assembled in the internal space 300 for holding the joint 02, and a power component 5 located on the other side of the main body 1. The power component 5 can drive the carrier 3 to approach the pipe holding mechanism 2, enabling the joint 02 held in the joint locating fixture 4 to connect to the end of the pipe body 01 held by the pipe holding mechanism 2.

In specific use, the user clamps the pipe body 01 through the pipe holding mechanism 2, then places the corresponding model of the joint 02 into the joint locating fixture 4, and installs the joint locating fixture 4 into the internal space 300 of the carrier 3. The power component 5 drives the carrier 3 to approach the pipe holding mechanism 2, enabling the joint 02 held in the joint locating fixture 4 to connect to the end of the pipe body 01 held by the pipe holding mechanism 2. Its structural design is simple and can achieve a quick connection between the joint 02 and the pipe body 01. Generally speaking, the pipe body 01 refers to a hose for conveying fluid. Depending on the size of the hose nozzle, different specifications of the joint 02 need to be assembled. This invention sets a detachable joint locating fixture 4, which can be used in combination with the carrier 3, to realize the rapid assembly of various models of pipe body 01 and joint 02, making it very convenient for the user to operate.

In a feasible implementation scheme, as shown in FIG. 1, the main body 1 is set as a horizontal installation platform.

In this embodiment, the pipe holding mechanism 2 includes a fixed seat 20 fixed on the main body 1, two positioning seats 21 sliding on the fixed seat 20, and a transmission component 22. The two positioning seats 21 are arranged symmetrically on the left and right, and the transmission component 22 is transmissionally connected to each of the positioning seats 21. The transmission component 22 can drive the two positioning seats 21 to approach each other to clamp the pipe body 01.

Each of the positioning seats 21 includes a slider 210, a pipe clamp 211, and a locking component 212. The slider 210 is slidably mounted on the fixed seat 20. The pipe clamp 211 is fixedly connected to the slider 210 through the locking component 212, and the pipe clamp 211 has a pipe clamping groove 2110.

Specifically, the transmission component 22 is drivingly connected to the slider 210.

The pipe clamping groove 2110 of the pipe clamp 211 is shaped with corrugated teeth 2111 corresponding to the corrugated structure of the pipe body 01.

In specific use, first place the pipe body 01 between the pipe clamping grooves 2110 of the two pipe clamps 211, and then use the transmission component 22 to drive the two sliders 210 to approach each other to clamp the pipe body 01. Furthermore, setting corrugated teeth 2111 in the pipe clamp 211 that correspond to the corrugated structure of the pipe body 01 can further enhance the clamping force and prevent the pipe body 01 from rotating or falling off.

In this embodiment, the transmission component 22 includes a bidirectional screw 220 rotationally mounted on the fixed seat 20 and a rotating handle 221 mounted on the end of the bidirectional screw 220. The bidirectional screw 220 has a forward thread portion 2200 and a reverse thread portion 2201. Each of the positioning seats 21 is provided with a first threaded hole 2100. The first threaded hole 2100 of one positioning seat 21 is transmissionally connected to the forward thread portion 2200 of the bidirectional screw 220, and the first threaded hole 2100 of the other positioning seat 21 is transmissionally connected to the reverse thread portion 2201 of the bidirectional screw 220.

When installing the pipe, the user rotates the rotating handle 221, thereby driving the bidirectional screw 220 to rotate. The rotating bidirectional screw 220 brings the two positioning seats 21 closer together through the forward thread portion 2200 and the reverse thread portion 2201.

In this embodiment, the carrier 3 includes a main shell 30, a split shell 31 hinged to the main shell 30, and a locking part 32 mounted on the main shell 30. The main shell 30 has a first split groove 3000. The split shell 31 has a second split groove 3001. The first split groove 3000 and the second split groove 3001 are combined to form the internal space 300 of the carrier 3. The split shell 31 can be opened or locked relative to the main shell 30, and the locking part 32 is used to open or lock the split shell 31 relative to the main shell 30 for the joint locating fixture 4 to be put in or taken out.

In a feasible embodiment, the locking part 32 includes a reset elastic component 320 and a locking plug 321. The main shell 30 has a first column hole 301, a locking slot 302 communicating with the first column hole 301, and a second column hole 303 communicating with the locking slot 302. The split shell 31 has a buckle foot 310 that can extend into the locking slot 302. One end of the locking plug 321 is equipped with a stop part 3210 for keeping the buckle foot 310 inside the locking slot 302. The reset elastic component 320 is located in the second column hole 303. The end of the locking plug 321 with the stop part 3210 passes through the first column hole 301, the locking slot 302, and extends into the second column hole 303, pushing against the reset elastic component 320. The other end of the locking plug 321 is exposed at the first column hole 301.

In the initial state, the split shell 31 and the main shell 30 maintain a locked state. At this time, the buckle foot 310 of the split shell 31 remains in the locking slot 302. When it is necessary to load the joint locating fixture 4 into the internal space 300, the user only needs to hold the locking plug 321, making the stop part 3210 of the locking plug 321 fully extend into the second column hole 303. This unlocks the stop action of the stop part 3210 on the buckle foot 310, which can make the split shell 31 open relatively. Its structure design is compact and very convenient for user operation.

In this embodiment, the joint locating fixture 4 includes two positioning blocks 40 that are set in halves and are relatively independent. Each positioning block 40 has a positioning groove 41. The two positioning blocks 40 are assembled in pairs and used in combination. After the positioning grooves 41 of the two positioning blocks 40 are combined, they form a positioning space 400 for clamping the joint 02. The type of joint locating fixture 4 also corresponds to various specifications. The size of the positioning groove 41 of each corresponding type of joint locating fixture 4 is consistent with the international standard size of the joint 02, which positions the joint 02.

In a more specific implementation plan, one end of each positioning block 40 far from the positioning groove 41 is configured as an opening. The inner wall of the opening is provided with an internal thread part 401. Generally speaking, inside the main body clamping mechanism 2 of the pipe body 01, the connecting end of the pipe body 01 extends to the opening of the positioning block 40. By setting the internal thread part 401, the worn and mixed threads at the connecting end of the pipe body 01 (like the mixed braided threads often appearing after the cutting wear of the braided hose end) can be better guided into the opening, so that the connecting end of the pipe body 01 is completely wrapped inside the joint 01.

In this embodiment, the power member 5 includes a base 50, a rotary screw 51, and a power handle 52. The base 50 has a second threaded hole 500. The rotary screw 51 is rotatably assembled in the second threaded hole 500 of the base 50. One end of the rotary screw 51 is fixedly connected with the carrier 3, and the other end of the rotary screw 51 is fixedly connected with the power handle 52. The power handle 52 can drive the carrier 3 towards the pipe holding mechanism 2 through the rotary screw 51, so that the joint 02 is screwed into the end of the pipe body 01. The user can drive the rotary screw 51 to screw in or out clockwise through the power handle 52 to achieve the carrier 3 moving towards or away from the pipe holding mechanism 2.

The above content is only the preferred embodiment of the present invention. For those skilled in the art, according to the idea of the present invention, there will be changes in specific implementation methods and application ranges. The contents of this specification should not be construed as limiting the invention.

I claim:

1. A multi-model pipe joint connection device, comprising
a main body (1),
a pipe holding mechanism (2) located on one side of the main body (1) for clamping a pipe body (01),
a carrier (3) with an internal space (300),
a joint locating fixture (4) that is detachably assembled in the internal space (300) for holding a joint (02), and
a power component (5) located on the other side of the main body (1); wherein the power component (5) can drive the carrier (3) to approach the pipe holding mechanism (2), enabling the joint (02) held in the joint locating fixture (4) to connect to one end of the pipe body (01) held by the pipe holding mechanism (2).

2. The multi-model pipe joint connection device according to claim 1, wherein the pipe holding mechanism (2) includes
a fixed seat (20) fixedly disposed on the main body (1),
two positioning seats (21) slidingly disposed on the fixed seat (20), and
a transmission component (22);
the two positioning seats (21) are arranged symmetrically on the left and right, and the transmission component (22) is transmissionally connected to the two positioning seats (21) respectively, and the transmission component (22) can drive the two positioning seats (21) to approach each other to clamp the pipe body (01).

3. The multi-model pipe joint connection device according to claim 2, wherein each of the positioning seats (21) includes
a slider (210),
a pipe clamp (211), and
a locking component (212); the slider (210) is slidably mounted on the fixed seat (20); the pipe clamp (211) is fixedly connected to the slider (210) through the locking component (212), and the pipe clamp (211) has a pipe clamping groove (2110).

4. The multi-model pipe joint connection device according to claim 3, wherein the pipe clamping groove (2110) of the pipe clamp (211) is shaped with corrugated teeth (2111) corresponding to the corrugated structure of the pipe body (01).

5. The multi-model pipe joint connection device according to claim 2, wherein the transmission component (22) includes
a bidirectional screw (220) rotationally mounted on the fixed seat (20) and
a rotating handle (221) mounted on one end of the bidirectional screw (220); the bidirectional screw (220) has a forward thread portion (2200) and a reverse thread portion (2201).

6. The multi-model pipe joint connection device according to claim 1, wherein the carrier (3) includes
a main shell (30), a split shell (31) hinged to the main shell (30), and a locking part (32) mounted on the main shell (30);
the main shell (30) has a first split groove (3000); the split shell (31) has a second split groove (3001);
the first split groove (3000) and the second split groove (3001) are combined to form the internal space (300) of the carrier (3); and the locking part (32) is used to open or lock the split shell (31) relative to the main shell (30) for the joint locating fixture (4) to be put in or taken out.

7. The multi-model pipe joint connection device according to claim 6, wherein the locking part (32) includes
a reset elastic component (320) and a locking plug (321);
the main shell (30) has a first column hole (301), a locking slot (302) communicating with the first column hole (301), and a second column hole (303) communicating with the locking slot (302);
the split shell (31) has a buckle foot (310) that can extend into the locking slot (302);
one end of the locking plug (321) is equipped with a stop part (3210) for keeping the buckle foot (310) inside the locking slot (302);
the reset elastic component (320) is located in the second column hole (303);
the end of the locking plug (321) with the stop part (3210) passes through the first column hole (301), the locking slot (302), and extends into the second column hole (303), pushing against the reset elastic component (320); the other end of the locking plug (321) is exposed at the first column hole (301).

8. The multi-model pipe joint connection device according to claim 1, wherein the joint locating fixture (4) includes two positioning blocks (40) that are set in halves and are relatively independent; each positioning block (40) has a positioning groove (41); the two positioning blocks (40) are assembled in a matching manner and used in conjunction, and after the positioning groove (41) of the two positioning blocks (40) are aligned, a positioning space (400) for clamping the joint (02) is formed.

9. The multi-model pipe joint connection device according to claim 8, wherein each of the positioning blocks (40) has an internal thread part (401) formed at one end away from the positioning groove (41), for guiding the end of the pipe body (01) to extend into the positioning space (400).

10. The multi-model pipe joint connection device according to claim 1, wherein the power member (5) includes a base (50), a rotary screw (51), and a power handle (52);
the base (50) has a second threaded hole (500); the rotary screw (51) is rotatably assembled in the second threaded hole (500) of the base (50);
one end of the rotary screw (51) is fixedly connected with the carrier (3), and the other end of the rotary screw (51) is fixedly connected with the power handle (52);
the power handle (52) can drive the carrier (3) towards the pipe holding mechanism (2) through the rotary screw (51), so that the joint (02) is screwed into the end of the pipe body (01).
